(19) United States
(12) Patent Application Publication
(10) Pub. No.: US 2014/0180934 A1
(43) Pub. Date: Jun. 26, 2014

(54) Systems and Methods for Using Non-Textual Information In Analyzing Patent Matters

(71) Applicant: Lex Machina, Inc., (US)

(72) Inventors: Mihai Surdeanu, Tucson, AZ (US); Ingrid Kaldre Foster, Redwood City, CA (US); Carla L. Rydholm, Los Gatos, CA (US); Ramesh Maruthi Nallapati, San Jose, CA (US); Joshua H. Walker, Los Altos, CA (US); George D. Gregory, Los Altos, CA (US); Gavin Carothers, Sebastopol, CA (US); Nicholas O. P. Pilon, Sebastopol, CA (US)

(73) Assignee: LEX MACHINA, INC., Palo Alto, CA (US)

(21) Appl. No.: 13/745,117

(22) Filed: Jan. 18, 2013

Related U.S. Application Data
(60) Provisional application No. 61/740,905, filed on Dec. 21, 2012.

(51) Int. Cl. G06Q 50/18; G06F 17/30

(52) U.S. Cl. CPC G06Q 50/184; G06F 17/30386
USPC 705/310

(57) ABSTRACT

Aspects of the present invention comprise using non-textual information in analyses of patent matters. In embodiments, patent matter similarity may comprise a combination of two or more metrics: (a) a metric that measures the textual similarity between an input patent portfolio and patent matters; (b) a metric that measures the behavior between portfolio patents and other patent matters at issue (e.g., which patents are asserted in the same proceeding with portfolio patents); (c) a metric that measures the textual similarity between the textual description and patent matters; and (d) a metric that inspects which patent matters are placed at issue by peer companies. In embodiments, patent matter similarity may be determined using textual similarity in combination with non-textual information.

### COPYRIGHT NOTICE

A portion of this patent document contains material which is subject to copyright protection. To the extent required by law, the copyright owner has no objection to the facsimile reproduction of the document, as it appears in the U.S. Patent and Trademark Office patent file or records, but otherwise reserves all copyright rights whatsoever.

### BACKGROUND

A. Technical Field

The present invention pertains generally to computer applications, and relates more particularly to systems and methods for using non-textual information in analyzing patent matters, such as discovery of similarity between patent matters.

B. Background of the Invention

Intellectual property, especially patent matters, have become increasingly more prominent as business assets. These patents assets have received increased media attention as they have been the subject of business transactions, such as patent auctions, and contested matters, such as patent litigations.

Because of the economic value of patent matters, there has been significant recent interest in patent information retrieval (IR) and, in general, in processing patent information. For example, the Conference and Labs of the Evaluation Forum-Intellectual Property (CLEF-IP) track was launched in 2009 to investigate IR techniques for patent retrieval and was part of the CLEF 2009 evaluation campaign. In 2010 and 2011, the track was organized as a benchmarking activity of the CLEF 2010 and 2011 conferences. The track and the corresponding workshop continued in 2012 under the same organization. In 2009, the CLEF-IP evaluation focused on finding patents that constitute prior art for a given collection of topics. The language of the topic documents was not restricted (i.e., it included English, French, and German).

In 2010, two kinds of tasks were proposed: (1) Prior Art Candidate Search Task: finding patent documents that are likely to constitute prior art to a given patent application; and (2) Classification Task: classifying a given patent document according to the International Patent Classification (IPC).

In 2011, four tasks were proposed: (1) Prior Art Candidate Search; (2) Classification; (3) Image-based Patent Retrieval, which involves finding patent documents relevant to a given patent document containing images; and (4) Image-based Classification, which involves categorizing given patent images into pre-defined categories of images (such as graph, flowchart, drawing, etc.).

The CLEF-IP evaluation track and workshop continues to the current time with four new tasks:

(1) Passage retrieval starting from claims (patentability or novelty search)—The topics in this task are intended to be based on the claims in patent application documents. Given a claim, the participants are asked to retrieve relevant documents in the collection and mark out the relevant passages in these documents.

(2) Matching claim to description in a single document (Pilot)—The topics in this task intend to match claims to portions of the patent specification. That is, given one claim in a patent application document, the participants are asked to indicate those paragraphs in the description section of the same application document that best explain the contents of the given claim.

(3) Flowchart Recognition Task—The topics in this third task are intended to deal with patent images representing flow-charts. Participants in this task are asked to extract the information in these images and return it in a predefined textual format.

(4) Chemical Structure Recognition Task—The topics in this fourth task is directed to patent pages in TIFF format, and participants are asked to identify the location of the chemical structures depicted on these pages. And, for each of them, participants are asked to return the corresponding structure in a chemical structure file format.

Another workshop that focuses on language technology for patent data (LTPD 2012) was organized in conjunction with the 8th International Language Resources and Evaluation Conference (LREC 2012). Driven by the large increase in multi-lingual patents (e.g., in China, the number of patents have been multiplied by 3 in 5 years and they exceed 1 million published documents per year currently), this workshop focuses on machine translation algorithms for patents and other tools for patent search and content management.

The First Symposium on Patent Information Processing (SPIP) was organized in December 2010, in Tokyo Japan. This symposium aims to foster research and development of the technology for patent information processing, with the following areas of interest: analysis and classification for patent documents, machine translation and translation aids for patent documents, contrastive studies for multilingual patent documents, language resources for patent documents, dictionaries and terminology databases for patent documents, parallel, comparable or monolingual corpora for patent documents, information extraction and information mining from patent documents, patent map development, evaluation techniques for patent translation, and patent information retrieval.

Lastly, the First International Workshop on Advances in Patent Information Retrieval (AsPIRe'10), collocated with the 2010 European Conference on Information Retrieval (ECIR), is another workshop that focused mainly on patent IR. The goal of this workshop was to gather scientists from these areas together to foster the collaboration among interdisciplinary areas and spark discussions on open topics related to information retrieval and machine translation in the intellectual property domain in order to advance the current state-of-the-art of patent search tools.

All these workshops and symposia generated a large body of work on patent processing. Nevertheless, all these works focus on the text of the patents to perform information retrieval, information extraction, machine translation, patent classification, or patent valuation. However, text-based approaches are inherently limited. For example, limiting to only text means that only certain facets of the patent documents are consider. Also, dealing with only text is fraught with the complexities of language and semantics, which is only exacerbated when dealing with patent documents, which are very complex both legally and technically.

Due to the ineffectual results of such prior approaches, what are needed are systems and methods by which non-textual information may be used in analyzing patent documents.

### BRIEF DESCRIPTION OF THE DRAWINGS

Reference will be made to embodiments of the invention, examples of which may be illustrated in the accompanying figures. These figures are intended to be illustrative, not limiting. Also, although the invention is generally described in the context of these embodiments, it should be understood that it is not intended to limit the scope of the invention to these particular embodiments.

FIG. 1 depicts a method for generating a graphical model according to embodiments of the present invention.

FIG. 2 depicts a more specific approach for generating a graphical model according to embodiments of the present invention.

FIG. 3 depicts a flow chart of how a Lexpressor classifier system uses Full Text Lexpressions and Semantic Unit Lexpressions in classifying or labeling a document according to embodiment of the present invention.

FIG. 4 depicts a methodology for extracting patent matters, such as extracting the asserted patents in each district court case from the pleading documents that were previously downloaded, according to embodiments of the present invention.

FIG. 5 depicts a methodology for name entity resolution according to embodiments of the present invention.

FIG. 6 depicts an embodiment of a taxonomy of legal entity types according to embodiments of the present invention.

FIG. 7 depicts a method for constructing a patent matter proceedings graph according to embodiments of the present invention.

FIG. 8 depicts an example of a patent matter proceedings graph according to embodiments of the present invention.

FIG. 9 depicts a system or architecture for generating patent matter similarity measures according to embodiments of the present invention.

FIG. 10 shows an example of measuring path distance according to embodiments of the present invention.

FIG. 11 shows another example of measuring path distance according to embodiments of the present invention.

FIG. 12 depicts a block diagram of an example of a computing system according to embodiments of the present invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or instructions on a tangible computer-readable medium.

Also, it shall be noted that steps or operations may be performed in different orders or concurrently, as will be apparent to one of skill in the art. And, in instances, well known process operations have not been described in detail to avoid unnecessarily obscuring the present invention.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components or modules. Components or modules may be implemented in software, hardware, or a combination thereof.

Furthermore, connections between components within the figures are not intended to be limited to direct connections. Rather, data between these components may be modified, re-formatted, or otherwise changed by intermediary components. Also, additional or fewer connections may be used. It shall also be noted that the terms “coupled” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of such phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. A set or group shall be understood to include any number of items.

Embodiments of the present invention presented herein will be described using patent matters examples. These examples are provided by way of illustration and not by way of limitation. One skilled in the art shall also recognize the general applicability of the present inventions to other applications.

A. General Overview

As noted above, prior attempts to analyze patent-related documents have focused on textual analyses. Due to the ineffectual results of such prior approaches, what are needed are systems and methods by which non-textual information may be used in analyzing patent-related documents. Thus, aspects of the current inventions involve generating patent-related analyses that involve non-textual models, whether alone or in combination with textual models. As presented herein, such combinations are beneficial because they can address features that cannot be extracted from text alone.

For purposes of explanation and not limitation, the present invention shall be described in terms of an application of embodiments of the present invention to determine patent matter similarity—although one skilled in the art shall recognize that the present invention may be applied for different inquiries or to different purposes. In embodiments, patent similarity involves finding patent matters among patent matter proceedings that are similar to an input patent portfolio of one or more patent matters. In embodiments, a “patent matter” shall be understood to mean one or more of issued patents, patent applications (including but not limited to regular national filings, reissue applications, reexamination applications, Patent Cooperation Treaty (PCT) applications, etc.), pre-filed patent applications or disclosures, or the like. It shall be noted that a “patent matter proceeding” (PMP or “proceeding,” for short) may be any event (which may also be referred to herein generally as a case, matter, event, occurrence, or transaction) in which a patent matter or matters are the items of interest, such as (by way of illustration and not limitation) a litigation, International Trade Commission (ITC) proceeding, patent office proceeding (such as, by way of illustration and not limitation, interference, derivation proceeding, ex parte reexamination, inter partes reexamination, inter partes review, protest, opposition, and the like), arbitration, mediation, licensing transaction, transfer pricing report, asset purchase agreement, cost sharing agreement, patent purchase agreement, acquisition, mergers, or a combination thereof. It shall also be understood that “patent matter(s) at issue” (PMAI) (which may also be referred as “at issue patent matter(s)”) are patent matters that are the subject matter of interest, in whole or in part, in any such proceeding. In embodiments, the phrase “contested patent matter proceeding” refers to those proceedings in which a patent matter at issue is being challenged (“contested patent matter”) in a proceeding, such as litigation, ITC, arbitration, or patent office proceeding.

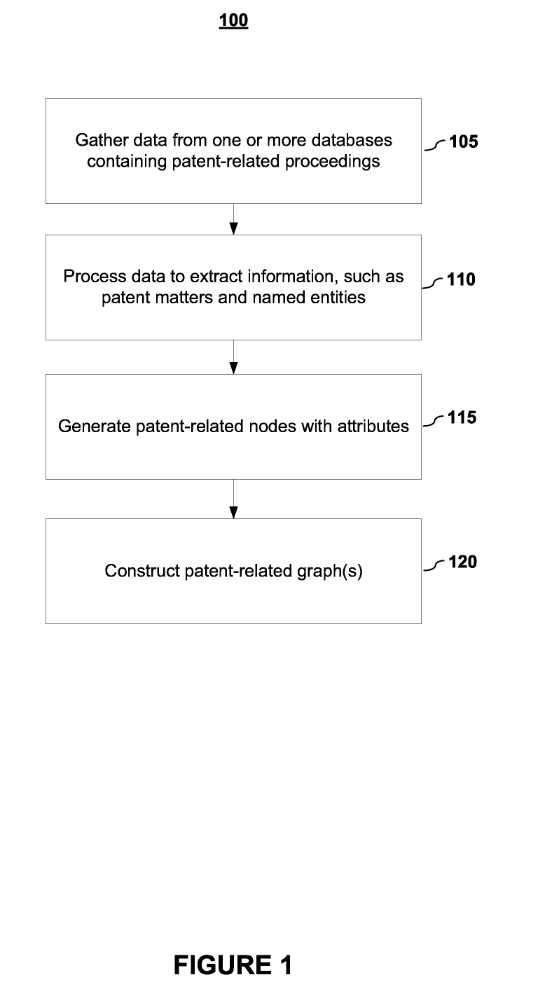

In embodiments, non-textual similarity information may be obtained by considering proximity information supplied via one or more graphical models. FIG. 1 depicts a method for generating a graphical model according to embodiments of the present invention.

As illustrated in the embodiment represented by FIG. 1, the processes commences by gathering (105) information from one or more databases containing patent matter proceedings. In embodiments, the information may be obtained by accessing relevant data repositories, such as court cases, patent offices, transaction deals records, etc.

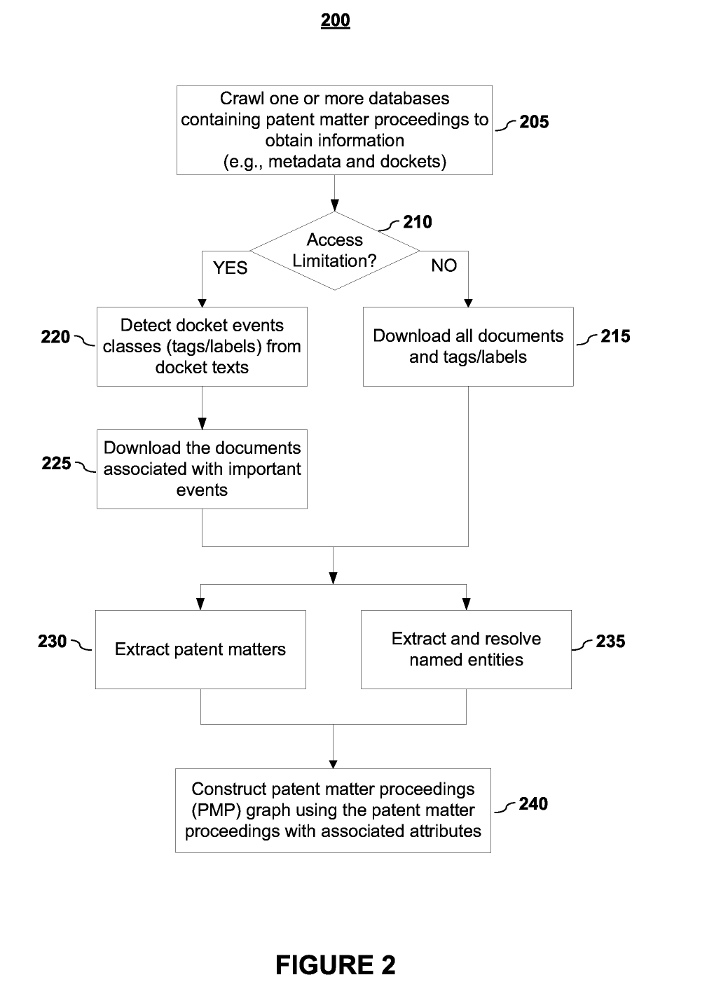

Having gathered data about patent matter proceedings, the data is processed (110) to extract specific information, such as patent matters and named entities. Because each repository may store and/or present the data in different ways, the extraction process may vary based upon the underlying source of the information. Embodiments that consider such situations are presented with respect to FIG. 2, below.

Having extracted specific information, in embodiments, this information may be used to create (115) patent-matter-related nodes, such as by way of example and not limitation patent-matter-proceeding nodes, with at least some of the extracted information comprising attributes of the nodes. These nodes may then be used to construct (120) a patent-matter-related graph or graphs that can be analyzed to supply non-textual information.

B. Graph Construction Embodiments

FIG. 1 presented a general overview for generating a graphical model according to embodiments of the present invention. FIG. 2 depicts a more specific approach for generating a graphical model according to embodiments of the present invention.

As shown in FIG. 2, data repositories are accessed to extract (205) information from the one or more data repositories containing patent matter proceedings. In embodiments, the information may be obtained by crawling relevant data repositories, which may be crawled using one or more dedicated crawlers. Examples of repositories for litigated matters include U.S. district and courts of appeal and the International Trade Commission (ITC). Examples of repositories for transaction matters may include government filings and collections of transaction documents.

The repository interface for the districts courts is the Public Access to Court Electronic Records (PACER) system, and the repository interface for ITC matters is the Electronic Document Information System (EDIS). Information may also be obtained from patent office data repositories, such as the United States Patent and Trademark Office (USPTO) and European Patent Office (EPO), as well as other. In embodiments, a crawler or crawlers interfaces with all the PACER instances in the district courts, EDIS, and other repositories, and download (205) metadata available about patent matter proceedings and the individual events for each particular proceeding, if applicable. Examples of the metadata include, but are not limited to, case title, case tags, filing date and termination date, parties involved, attorneys, law firms, judge, filing district, and the like.

In the embodiment depicted in FIG. 2, an inquiry is made (210) regard whether a repository has a limitation regarding access to a repository of records regarding patent matter proceedings (PMP). For example, PACER charges for each page that is download, whereas the ITC repository (EDIS) offers all of its documents for free. Also, the ITC repository also offers additional metadata, such as docket event tags, that the PACER databases do not. Therefore, in situations in which there is no limitation on access to the repository, event tags and the attached documents are downloaded (215).

However, in situations in which there are limitations on access to the repository, alternative approaches may be taken. Consider, by way of illustration the PACER system, which comprises document for district court litigation proceedings. PACER charges for its system based upon the number of downloaded document pages. Given the large volumes that could be downloaded, the costs are substantial. One approach to reduce costs is to download only the key filings, such as complaints, claim constructions, invalidity contentions, etc. However, in the case of the PACER system, it provides minimal metadata associated with the dockets. For example, the PACER repositories provide filing date of a document but do not indicate the event type, such as whether the filing was an order, pleading, etc. This paucity of metadata makes selecting and downloading the correct types of documents more challenging. Therefore, to minimize the download costs for district cases, embodiments of the present invention may employ an approach the same as or similar to that presented at Steps 220 and 225 of FIG. 2.

As depicted in FIG. 2, an attempt is first made to detect the class of each docket event from its docket texts (e.g., such as the title, which might read, for example, “COMPLAINT and Demand for Jury Trial against XYZ Corporation (Filing fee $350 receipt number 0111-2222222.)”). In embodiments, the detection of document class may be obtained by analyzing the text associated with a docket entry. One skilled in the art shall recognize that many keyword searching, natural language grammars and systems, and other such techniques may be employed. Presented below are embodiments of a natural language system.

1. Natural Language Processing

a) Lexpressions

Although many systems and methods may be used for classifying docket entries, in embodiments, a new language, which may be referred to herein as Lexpressions, is used to help identify document classifications. Lexpressions represents a new language or syntax for expressing complex text patterns in the task of classifying docket entries, documents, and cases into specific tags, which may be user-defined tags.

(i) Basic Lexpressions

In embodiments, in addition to metacharacters and boolean operations, Lexpression may comprise a number of complex expressions. In embodiments, Lexpressions may use Java Regular expressions as building blocks (thus, any Java regular expression operator may be used), but may also implement more expressive functionality. Presented below, by way of illustration and not limitation, are some basic Lexpressions.

(1) Basic Regular Expressions

In embodiments, any Java Regular Expression may be used as a legal Lexpression. Below are some examples:

den(ying|ied) matches both “denied” as well as “denying”

injun?ction matches “injunction” as well as “injuction”

j(ud)?ge?m(ent)? matches “judgment”, “judgement”, “jgm”, etc.

\bden matches “deny”, “denying”, “denied” as well as “denote”

\bdeny\b matches only “den”

In embodiments, expressions may be ordered—these may be of the form A,B,C where A, B, and C are basic Lexpressions. These Lexpressions match any text that contains A, B, and C, in that ordering, with no restriction on the distance of separation between any consecutive features. In embodiments, a user may use arbitrary spacing preceding or succeeding the “,” operator. For example, Lexpressor treats “A,B,C” or “A, B, C” or “A,B, C” as one and the same. Following is an example:

(2) Exact Phrases

In embodiments, exact phrases may be searched. Below is an example:

“summary judgment” matches “summary judgment” but not “summary of judgment”

(3) Grouping of Exact Phrases and Regular Expressions

In embodiments, exact phrases and regular expression may be grouped. Below is an example:

(“memorandum in support”|brief(s)?|application) matches either the phrase “memorandum in support”, “brief”, “briefs”, or “application”

(4) Basic Negations

In embodiments, negation of a word, words, phrase, phrases, or combinations thereof may be used. Below is an example:

-(injunction|“temporary restraining order”) matches with a text that does not match the grouping (injunction|“temporary restraining order”)

(ii) Ordered Lexpressions:

In embodiments, an expression or expressions may be ordered. Presented below are some of the possible ordering configurations.

(1) Basic Ordered Lexpressions

order, (grant|deny)ing, (“summary judgment”|sj) matches “order by court granting plaintiff's motion for summary judgment” as well as “order and opinion by judge denying defendant's sj motion”

(2) Ordered Lexpressions with Gap Restriction

In embodiments, ordered Lexpressions with gap restriction are of the form A, B, ˜n, C, which represents an ordering of Lexpressions A, B, and C with the additional restriction that B and C are separated by at most n words between them. Following is an example:

order, ˜1, “summary judgment” matches “order on summary judgment” and “order re: summary judgment” but not “order granting motion for summary judgment”

(3) Ordered Lexpressions Containing Negations

In embodiments, ordered Lexpressions containing negations capture non-occurrence of a basic Lexpression within an ordered context. The contextual Lexpressions may be any of the Lexpressions mentioned above. In embodiments, there is only one basic Lexpression with a negation in a whole Lexpression. Some examples are provided below:

order, stay, -(action|case|proceedings) matches any text containing order followed by stay at an arbitrary distance such that stay is not followed by action, case, or proceedings at any distance.

order, -stay, judgment matches text that contains order followed by judgment at an arbitrary distance but does not contain stay in between. This however matches with strings such as “order that judgment is stayed” because stay occurs to the right of judgment.

(iii) Unordered Lexpressions

In embodiments, an unordered Lexpression is of the form A_B_C, where A, B, and C are basic Lexpressions. These Lexpressions match any text that contains A, B, and C in any ordering. Similar to the “,” operator, a user may use arbitrary spacing preceding or succeeding the “_” operator. For example, “A_B_C” or “A_B_C” or “A_B_C” may be treated as one and the same. Below is an example:

order_(grant|den(ying|ied))_limine matches “order granting motion on limine”, “order that motion on limine is denied”, “motion on limine is hereby denied by judge's order”

(iv) Start Lexpressions

In embodiments, there is another type of Lexpression that matches with the beginning of text. These Lexpressions can be important for many docket classification tasks since the beginning of text tends to contain crucial information on the events that it discusses. In embodiments, “Start” Lexpressions are of the form ̂X or ̂˜n, X, where X is any nested Lexpression. Provided below are some examples:

̂order, grant, ˜2, stay matches text starting with “order granting motion to stay”, but not “motion for order granting stay” or “order granting motion of plaintiffs to stay”

̂˜2, judgment, injunction matches any text that starts with at most two words followed by judgment, followed by injunction (e.g., this lexpression matches “final judgment and permanent injunction” and “order and judgment by Judge Alsup on permanent injunction” but not “motion for order and judgment on permanent injunction”).

(v) Window Lexpressions

In embodiments, Lexpressions may examine text related to a certain specified window size or sizes. Examples of the syntaxes for these Lexpressions are shown below.

(1) Ordered Window Lexpressions

In embodiments, an ordered window Lexpression may be used to capture text within a window size specified by the user. Two examples are provided below:

{judge, order, judgment &5}, stay matches any text that contains judge, order, judgment such that all three words occur within 5 words in the same ordering.

{order, granting, ˜2, stay &7} matches text that starts with order followed by granting followed by stay such that granting and stay are separated by no more than two words, and all three words occur within a window of 7 words.

(2) Ordered Window Lexpressions with Negations

In embodiments, these Lexpressions capture negations within ordered Lexpressions. Some examples are provided below:

{order, -grant, stay &10} matches any text that contains order and stay in that ordering within 10 words, such that grant does not occur between them.

{-order, grant, stay &10} matches grant and stay in that ordering such that grant is not preceded by order within a window of 10 words.

{order_-grant_stay &10} matches order and stay in any order in a window of 10 words such that grant does not appear in that window.

(3) Unordered Window Lexpressions

In embodiments, these unordered window Lexpressions may also be formed. An example is provided below:

{order_grant_stay &10} matches any text that contains order, grant, and stay in any ordering such that all the three words occur within a window of 10 words.

(4) Window Lexpressions with Start Constraint

In embodiments, window Lexpressions with start constraint carry the syntax of window Lexpressions with the additional constraint that the window must start within a few words from the beginning of the text. Some examples are provided below:

̂˜10, {order, grant stay &10} matches a text that contains order, grant, and stay in the same ordering within a window of 10 words, but also where the word order starts within 10 words from the beginning.

̂˜10, {order_grant_stay &10} matches a text that contains order, grant, and stay in any ordering within a window of 10 words, but also where the word the first word in the window is within 10 words from the beginning of the text.

(vi) Complex Negations

In embodiments, these Lexpressions may be negations of any complex Lexpressions, such as Ordered Lexpressions, Unordered Lexpressions, Window Lexpressions, or Starting Window Lexpressions. Two examples are provided below:

-{̂˜10, (order|opinion)} matches any text that does NOT contain either the word order or the word opinion in the first 11 words of a text.

-{order, grant, dismissal &5} matches an input that does NOT contain an ordered window of the words order, grant, and dismissal of size less than or equal to 5 words.

(vii) Compound Lexpressions

(1) Conjunctions

In embodiments, the syntax for this type is X AND Y, where X and Y are both Lexpressions. A conjunction matches a text if both X and Y match the text. An example is provided below:

order_(grant|den(y|ied))_“summary judgment” AND—“without prejudice” matches “order granting motion for summary judgment”, but not “order that motion for summary judgment is denied without prejudice”.

(2) Disjunctions

In embodiments, the syntax for this type is X OR Y, where X and Y are both Lexpressions. A disjunction matches a text if either X or Y match the text. An example is provided below:

{case, stayed &3}” OR {order, stay &3} matches “order granting stay”, as well as “order that case is stayed”.

One skilled in the art shall recognize that other operations and syntaxes may be employed and form part of this disclosure. Also, one skilled in the art shall recognize that these operators and syntaxes may be combined in numerous ways.

b) Classification—Lexpressor

In embodiments, the Lexpression syntax may be used in a binary classifier, which for convenience may be referred to herein as the Lexpressor classifier or Lexpressor, that labels an input text into one of “positive” and “negative” classes with respect to a specific tag. The label “positive” implies that the text discusses the event/issue represented by the tag and “negative” implies the contrary. It shall be noted that the performance of classifier will depend to a great extent on the quality of the Lexpressions defined by a user. Hence, it is beneficial for a user to understand how the classifier system operates on a user-defined Lexpressions. This section describes embodiments of an architecture of the Lexpressor system, which may be used to tag docket entry text with events based on the Lexpressions defined by a user.

(i) Two levels of Lexpressions

In embodiments, the Lexpressor classifier assumes that the user defines two sets of Lexpressions: (i) Full Text Lexpressions, and (ii) Semantic Unit Lexpressions. In embodiments, for docket entry text, each semantic unit is a clause that expresses a specific action such as “order granting motion for summary judgment.” For a document text, the semantic unit may be a regular sentence. In embodiments, the Lexpressor classifier can break a text into semantic units based on whether the tag is a DocketTag, a DocumentTag, or a CaseTag. In embodiments, the implementation is the same for DocumentTag and CaseTag because they both operate on documents as input.

In embodiments, a user enters Full Text Lexpressions and Semantic Unit Lexpressions in separate files in the following format in each line:

Lexpression=>label

where “label” is one of “+”, “−” or “++”, the meaning of which will be explained below. For example, the user may enter the following Lexpressions in the Full Text Lexpressions file:

̂˜0.3, injunction=>+

̂“temporary restraining order”=>++

proposed=>−

and the following in the semantic unit level Lexpressions file:

order_(grant|den(y|ied))_injunction=>+

“without prejudice” AND “permanent injunction”=>−

order, enjoin=>+

proposed=>−

(ii) Computing Output Label from Lexpression Labels

In embodiments, the Lexpression may be assigned a precedence order. For example, in embodiments, given an input text (full text or a semantic unit), the Lexpressor classifier matches the text against the corresponding set of Lexpressions and outputs the final label using the following precedence order:

++>−>+

That is to say, if the text matches with any Lexpression that has a “++” label, the classifier returns “positive” as the final label irrespective of whether or not the text matches with other Lexpressions. If no match with a Lexpression that has “++” label is found, but the text matches with Lexpressions with “+” and “−” labels, then “−” takes precedence over “+” and the Lexpressor classifier returns “negative” as the final label. If no “−” match is found but one or more “+” matches are found, the Lexpressor classifier returns “positive” as the final output.

(iii) Embodiments of the Lexpressor Classifier and Examples

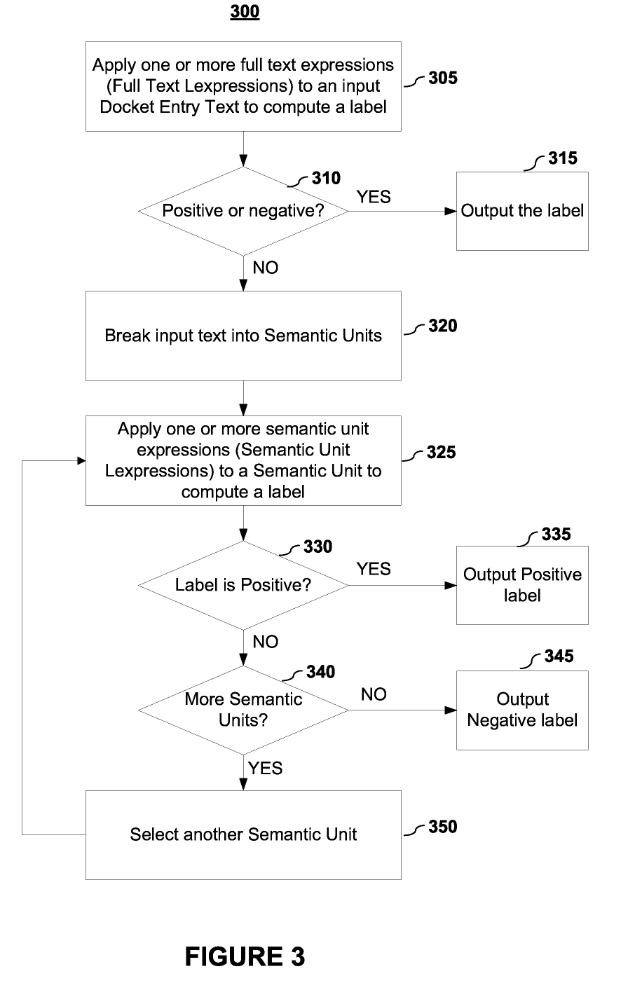

FIG. 3 depicts a flow chart of how a Lexpressor classifier system uses Full Text Lexpressions and Semantic Unit Lexpressions in classifying or labeling a document according to embodiment of the present invention. As shown in the embodiment depicted in FIG. 3, the methodology commences by analyzing the full text of an input text (such as, by way of example, a docket entry) to compute (305) a label by matching the text against one or more docket level Lexpressions. An inquiry is made (310) whether a label (either positive or negative) was successfully identified. If the classifier detected a positive or negative label, that positive or negative label is output (315). In embodiments, if a label has not been clearly identified, the classifier breaks the full text of the docket entry into Semantic Units, which may be a clause for Docket Entry classification or a sentence for Document classification. In embodiments, the text may be divided Semantic Units based on punctuation (e.g., semicolons) or other cues. It shall be noted that analyzing text to divide it into units is well known to those of skill in the art and such methods may be applied herein.

In the embodiment depicted in FIG. 3, the Lexpressor classifier method continues by analyzing each Semantic Unit in turn. For a Semantic Unit, the classifier attempts (325) to match its text against the Semantic Unit level Lexpressions to discern a label. If a positive label is detected (330), the classifier returns (335) the positive label. If a positive label is not detected for that Semantic Unit, the classifier determines (340) whether another Semantic Unit has yet to be analyzed. If another Sematic Unit exists that has not yet been processed, the next Semantic Unit is selected (350), and the process returns to Step 325 in order to analyze that Semantic Unit. If no more Semantic Units remain (340) to be analyzed, the classifier returns (345) a negative label.

Consider, by way of illustration and not limitation, a few examples. For purposes of the examples, assume a user defines the Full Text level and Semantic Unit level Lexpressions as shown in subsection B.1.b)(i), above. If the input text is “Temporary restraining order and proposed judgment.”, in embodiments, the classifier first analyzes the whole docket text and it finds matches with the Full Text level Lexpression “temporary restraining order” with label “++” and also the Full Text level Lexpression “proposed” with label “−”. Since “++” has a higher precedence than “−”, the Lexpressor classifier embodiment outputs the final label as “positive,” and does not enter the Semantic Unit level.

However, if the input text is “Proposed injunction order by plaintiffs.”, the classifier matches with the Full Text level Lexpression “̂˜3, injunction” which has a “+” label and also “proposed” with label “−”. Since the label “−” has higher precedence than “+”, the final label is output as “negative.”

As the last example, consider the text “order enjoining defendants; final judgment”. The text does not match any of the Full Text Lexpressions. Hence, the Lexpressor classifier divides the text into Semantic Units (clauses in this case) using the semicolon as separator and matches each clause against the clause level Lexpressions. In embodiments, the clauses for this text are “order enjoining defendants” and “final judgment”. The first clause matches the clause level Lexpression “order, enjoining” with label “+” and none else. Hence, the Lexpressor classifier outputs “positive” as the final label without analyzing the next clause.

FIG. 3 depicts an example of using a classifier with Lexpressions to classify content according to embodiments of the present invention; it shall be noted that one skilled in the art could use the classifier system with various Full Text Lexpressions, Sematic Unit Lexpressions, or combinations thereof to classify a variety of content. Accordingly, such modifications shall be considered within the scope of the current patent document.

Having described embodiments of a natural language syntax (Lepressions) and a classifier system (Lexpressor), such tools may be used to classify items (e.g., docket items) to identify key events. Returning to FIG. 2, Step 220, as previously stated, an attempt is first made to detect the class of each event from its texts (such as, by way of example and not limitation, classifying a docket event from its title). In embodiments, the detection of the document class may be obtained using Lexpressions and a Lexpressor classifier, as explained above. Having obtained labels, or tags, that identify the items, the key documents associated with important events (e.g., pleadings, court decisions, etc.) are downloaded (225), thereby saving time and money.

It shall be noted, however, where cost is not a limiting factor, all PACER documents may also be downloaded (215) without first attempting to discover and tag the important events. Although, in embodiments, even if all documents are downloaded, tags or labels for the docket items may still be obtained by classifying the downloaded items in order to facilitate subsequent processing as explained below.

In embodiments, whether the tags/labels are supplied by the repository (e.g., for ITC documents) or are have been obtained through classification (e.g., for PACER documents), at this stage relevant documents for each particular matter have been downloaded and stored in one or more databases, which for convenience may be referred to herein as the LMI (Lex Machina, Inc.) database. In embodiments, along with the stored downloaded documents, there are associated metadata that may have been downloaded, obtained via classification, or both. Thus, in embodiments, each proceeding comprises some or all of the documents associated with its docket and metadata including one or more tags that classify these documents based on their type (e.g., it is know which documents are pleadings and which documents are court judgments, etc.). In embodiments, in addition to the metadata for each document, there may be metadata comprising information relevant for the entire proceeding, such as: filing date, termination date, district where filed, judge, parties involved (e.g., plaintiffs and defendants), and judge. Note that, in some instances, case-level metadata may be downloaded as raw text, which may be further processed. In embodiments, this information forms inputs into the next processes: (1) extracting (230) patent matters at issue; and (2) extracting (235) names.

2. Extracting Patent Matters at Issue

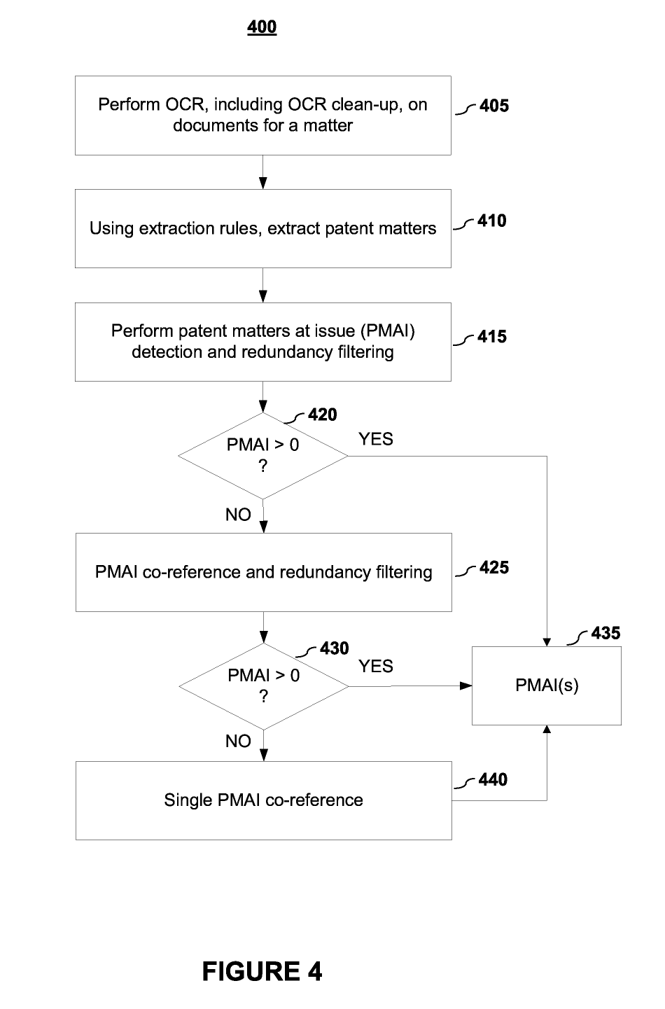

In embodiments, patent matters are at issue in each proceeding from the retrieved documents. In the case of ITC matters, the EDIS repository provides a list of asserted patents in each proceeding; however, PACER does not readily provide such information and thus it must be extracted. Similarly, in most transactional matters, at least one exhibit or section of the transactional documents includes a listing of the patent matters at issue in the transactional proceeding. Accordingly, Step 230 represents the extraction of patent matters, if needed. FIG. 4 depicts a methodology for extracting patent matters (e.g., extracting the asserted patents in each district court case from the pleading documents that were previously downloaded, or extracting patent matters from licensing documents), according to embodiments of the present invention.

In embodiments, the methodology of FIG. 4 may be performed for each individual proceeding in the LMI database of downloaded proceedings. As shown in FIG. 4, the methodology receives as input all the relevant documents for a proceeding (e.g., the pleading documents for a patent case in district court) and performs (405), if appropriate, optical character recognition (OCR) to convert the scanned documents into digital text. In embodiments, an off-the-shelf OCR system may be used, and it shall be noted that no particular OCR system is critical. Because no OCR system is able to correctly recognize every text element, the initial OCR results are likely to contain errors. Embodiments of the current methodology includes at least two elements to help counter the error problems.

First, as part of the OCR process, embodiments of the present methodology may also include performing OCR clean-up operations. For example, the OCR output may be examined for any non-English letters, which can be converted to an English character. Additionally or alternatively, all Unicode codes output by the OCR engine may be replaced with the actual character, and any non-ASCII (i.e., ASCII codes less than 32 and higher than 127) may be replaced with white space.

Second, as explained in more detail below, embodiments of the patent matter extraction methodology have been designed to be robust to handle imperfect OCR results, even if no post-OCR clean-up is performed.

It shall be noted that the OCR step 405 is typically not required for electronic PDF documents because such documents generally include the raw text as a field. This situation is common for documents filed in litigation proceedings after 2005. For such documents, the raw text from the PDF files is simply extracted. Thus, after this step, for each document processed, there is a corresponding raw text representation, either produced by the OCR engine or extracted directly from the PDF.

From the raw text (from OCR results, from the extracted PDF raw text, or both), all mentions of patent matter numbers (such as application numbers, issue patent numbers, publication numbers, etc.) are extracted (410). In embodiments, this extraction process is implemented using a grammar developed using ANTLR (ANother Tool for Language Recognition), which is a parser generator. One skilled in the art shall recognize that other parser generators and rules may be employed. These rules capture the structure of patent number mentions, e.g., the fact that mentions may start with a country name (e.g., “U.S.”) followed by patent type (e.g., “Design”) followed by a number. All the possible variations may be implemented using ANTLR rules—examples from the corresponding ANTLR grammar are provided herein:

patent: THE? country? PATENT_TYPE? patent_head patent_number_enum

patent_head: PATENT|PATENTS

patent_number_enum: patent_number cc patent_number|patent_number

patent_number: THE? country? APPOSTROPHE? PATNUMBER PATNUMBER_SUFFIX? (LP nonrp+ RP)?

Because the above grammar may be applied on noisy text generated by OCR, OCR-based errors may creep into the grammar output. In embodiments, the extraction process (410) may include filtering at least some of these errors using a patent matter mention cleanup step. In embodiments, the patent matter mention cleanup may comprise two heuristics.

In embodiments, one heuristic involves removing patent matter mention outliers. For example, if a patent matter number occurs a disproportionately small number of times or below an absolute number of times within the OCR data, that number may be removed. In embodiments, patent matter numbers that are observed in less than 3% of the average number of sentences for all numbers extracted are removed, although other threshold values may be used. For example, if patent number X is extracted from a single sentence and the average number of sentences containing patent number Y is 50, patent number X is considered an outlier and is removed. One skilled in the art shall recognize that other heuristic and statistical methods may be employed for determining outliers.

In embodiments, another heuristic involves removing patent matter numbers that differ by a single digit from other extracted numbers that are more common. For example, this heuristic would remove the U.S. Pat. No. 5,123,456, if the U.S. Pat. No. 5,128,456 was more common in the same proceeding. One motivation for this heuristic is that, in general, OCR algorithms perform less well in recognizing numbers, and it is more likely that patent matter numbers are incorrectly extracted by one digit.

Once the noise has been removed or at least reduced from the extracted mentions of patent matter numbers, an analysis is performed to identify (415) the patent matters at issue (PMAI). The patent matters at issue represent the patent matters that are the principal patent matters for a particular proceeding (contested or transactional). For example, the patent matters at issue in a litigation would be the asserted patents as opposed to patents cited in a lawsuit for other reasons, such as prior art. The patent matter at issue in a reexamination would be the patent that is under reexamination. Or, the patent matters at issue in a licensing deal would be the patent matters that are subject to licensing.

In embodiments, the heuristics used at step 415 mark a patent matter as a patent matter at issue if the patent matter number appears in the same sentence or word grouping with keywords related to the particular proceeding. For example, if the proceeding is a litigation, a patent is identified as a patent matter at issue if its patent number appears in the same sentence with keywords indicating assertion or the like depending upon the proceeding. In embodiments, the following regular expression may be used to identify assertion keywords: “infringlvalidlinvalidlunenforc|̂renforce|̂enforcing”. This regular expression matches words such as “infringement”, “infringed”, “invalidity”, and so forth. In embodiments, to control for noise in the data, a redundancy threshold may be set that requires that the patent number and keyword match condition must occur above a set number of times, for example at least twice. That is, a patent would be classed as a patent matter at issue if at least two sentences match the above criteria.

Alternatively, in embodiments, additional criterion or criteria may be used. For example, in embodiments, a criterion that none of the sentences identified previously can match patterns that indicate that the discussion is about previous litigation or prior art. For example, the following patterns may be used to identify these issues: “prior\s*art”, “reference”, “failure\s*to\s*disclose”, “as\s*anticipated\s*by”, “in\s*light\s*of”. If any of the sentences contain such a pattern, they are discarded.

In embodiments, if at least one patent matter at issue is identified (420), the patent matter or matters at issue are output (435).

In some instances, no patent matters at issue may be identified because of the way in which the documents reference the patent matter or matters. For example, the approach describe above may be less effective for pleadings that list all asserted patents at the beginning of the document and then refer to all of the asserted patent matters in bulk as “the patents-in-suit” or some other group designator. In such situations, there may be no sentences containing explicit patent matter numbers and keywords indicating assertion. Rather, the actual assertion statements are phrased along the lines “the patents-in-suit are infringed” or the like. In embodiments, to address these situations, the above extraction step 415 may be reapplied (425) but searching for the phrase “patents-in-suit,” “licensed patents” (for a transactional matter), or the like instead of the actual patent numbers. If at least one patent matter at issue is identified (430), the patent matter or matters at issue are output (435).

In embodiments, if the number of patent matters at issue is still zero (430) and the number of unique candidate patent matter numbers extracted in the extraction step 410 is 1, a search for statements that appear jointly with the word “patent” is performed (440). A motivation for this step is that for matters that involve a single patent matter, particularly litigations, the contested or assertion statements are generally less formal than in other lawsuits and may or may not reference the actual patent number. This step captures this situation.

Embodiments of identifying patent matters at issue have been set forth above. However, it shall be recognized that other approaches may be used that are within the ability of those of with ordinary skill in the art and fall within the scope of the current disclosure.

3. Named Entity Resolution (NER)

Returning to FIG. 2, Step 235, in embodiments, names for the proceedings (parties, attorneys, lawsuits, judges, examiners, inventors, applicants, etc.) are obtained from the proceeding metadata. It shall be recalled that metadata on the names of the entities involved in a particular proceedings may be obtained directly from some of the repositories. Because this information is provided in the metadata, it is not necessary to extract it from the raw text. However, in embodiments, in the event that name information is not provided in the metadata, the names may be extracted from the text.

In embodiments, names received from metadata, or otherwise extracted, are considered to be raw, non-normalized data as it was likely input by different people and with many different spelling (legal or not) for the same entity. Thus, in embodiments, the names are resolved (235).

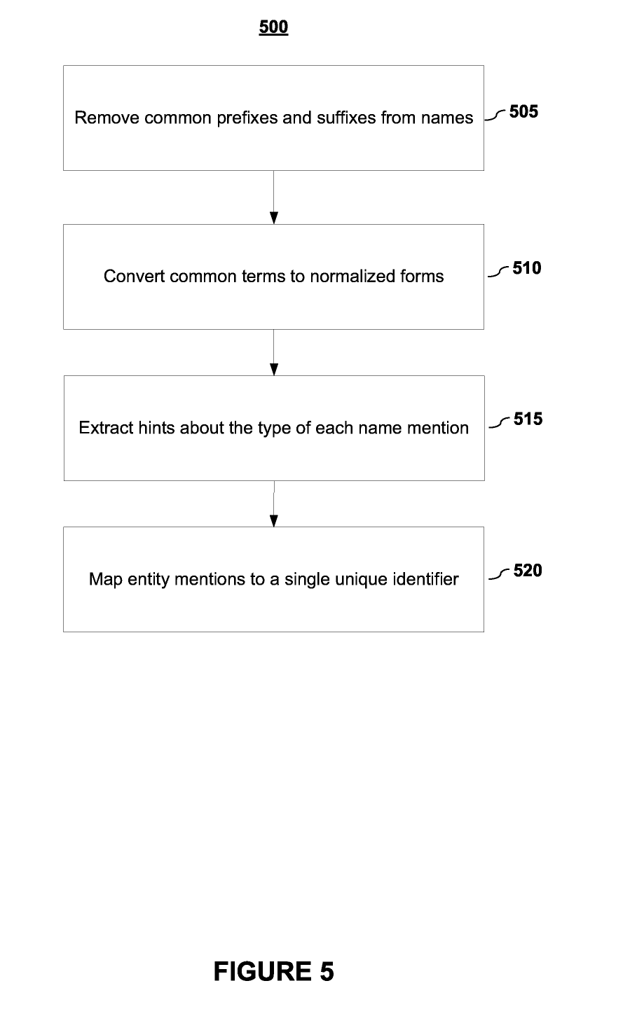

In embodiments, a name entity resolution (NER) methodology is a rule-based system that implements a two-step architecture for resolving the various combinations of names. In embodiments, a first step involves normalizing all names; and a second step involves clustering entity mentions based on the information extracted during normalization. FIG. 5 depicts a methodology for name entity resolution according to embodiments of the present invention.

In embodiments, the normalization process starts by removing (505) common prefixes (e.g., titles for person names) and suffixes (e.g., company name suffixes such as “Ltd.”) from names. In embodiments, more than 140 regular prefix and suffix expressions are used. Next, some common terms in organization names are converted (510) to a normalized form. For example, both “Holding” and “Holdings” are changed to “Hldg”. In embodiments, around 28 regular expressions are used for this conversion step. A few examples of case-insensitive rules are listed below:

“acquisition” is transformed to “acq”

“chemicals” is transformed to “chemical”

“international” and “int'l” are both transformed to “intl”

“pharmaceuticals” is transformed to “pharma”

“fund” and “fnd” are both transformed to “fd”

Because of the above step, names that originally used non-normalized forms of these terms (e.g., “Holdings”) now match with other similar names where these terms are already normalized (e.g., “Hldg”).

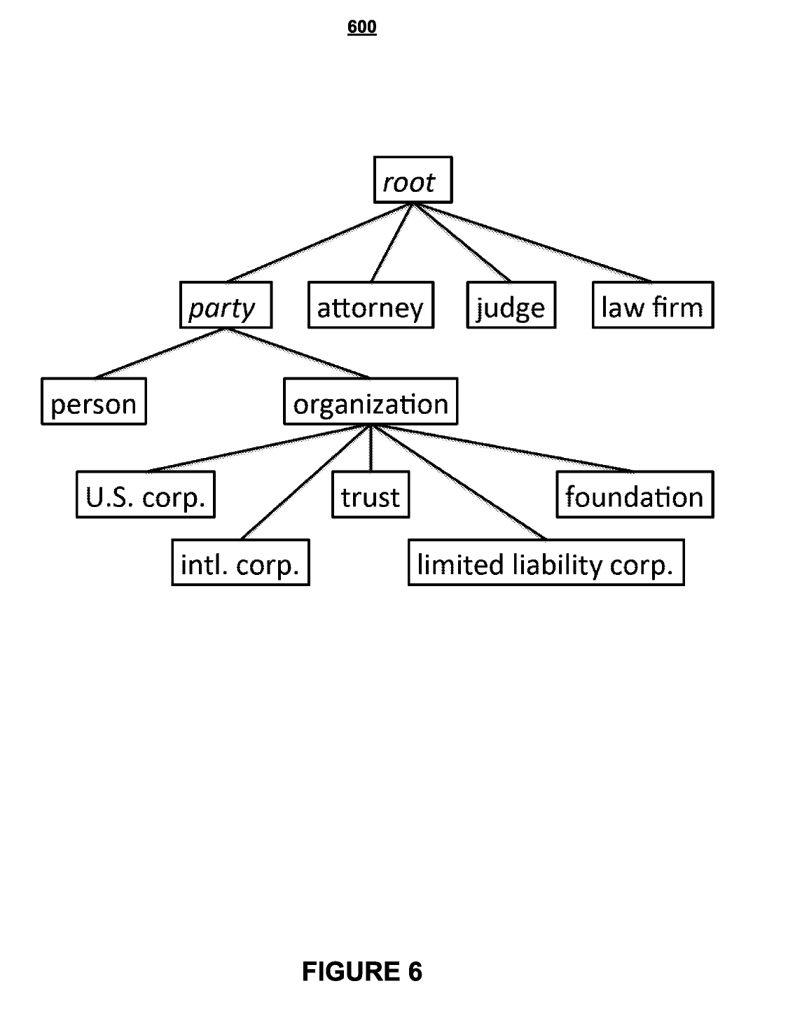

In embodiments, during the name resolution process, hints about the type of each mention are extracted (515). For example, the “Corp.” suffix indicates an organization incorporated in the U.S., whereas “Ltd.” indicates an organization registered outside of the U.S. Using this information and the case matter metadata, each entity mention may be mapped to a type in the taxonomy shown in FIG. 6.

FIG. 6 depicts an embodiment of a taxonomy of legal entity types according to embodiments of the present invention. In the example taxonomy depicted in FIG. 6, the categories in italicized font (root, party) are abstract types with no actual instances. In embodiments, the organization category is assigned to party names that could not be classified into one of the other known party types. In embodiments, the purposes of this taxonomy are: (a) to control the clustering of entity mentions (which will be discussed in more detail below), and (b) to trigger additional normalization rules for specific types. For example, a company incorporated in the U.S. is legally different from an international company with the same name, so they should not be merged. Furthermore, in embodiments, judge and attorney names may benefit from additional normalization steps. By way of examples and not limitations, for attorney names, a middle name (if present) may be converted to an initial; or for judge names, specific titles such as “magistrate judge” may be removed.

Returning to FIG. 5, entity mentions are mapped (520) to a single unique identifier, which is defined by the normalized names generated after steps 505 and 510 and a unique type, generated by step 515. For example, the normalized forms for “Microsoft Co.” and “Microsoft Corporation” are both “Microsoft” with the type “U.S. corp.”, given by the suffixes. Thus, the two names are considered from this point forward as representing the same real-world entity, a United States corporation identified by “Microsoft”.

In embodiment, compatible mentions may be detected using two different heuristics, depending on mention type:

(1) for all types other than law firm, two mentions are compatible if they have the same normalized form and the two types are either identical or one is a hypernym of the other in the type taxonomy; and

(2) for law firm mentions, at least two tokens in each of the corresponding names should be equal (or have significant overlap), and one of these tokens should be the first token in each name. This heuristic is beneficial because law firms are generally partnerships with dynamic structures and names. While the first partner does not usually change in a law firm name, it is very common that newer partners are added in time or that some leave, which leads to many variations of the law firm's name. For example, the “Quinn Emanuel, LLP” law firm has 89 different spellings in the LMI database (e.g., “Quinn Emanuel,” “Quinn Emanuel et al.,” “Quinn Emanuel Urquhart,” “Quinn Emanuel Urquhart Oliver & Hedges, LLP,” etc.).

4. Constructing a Litigation Graph

As a result of the Extracting Patent Matters At Issue process and the Name Entity Resolution process, additional information has been obtained that is helpful for constructing a patent matter proceedings (PMP) graph. In embodiments, this additional information is the patent matter(s) at issue in each proceeding and the normalized names. For example, for a litigation, the output comprises the patents asserted in each case and normalized names for all entities involved in these lawsuits.

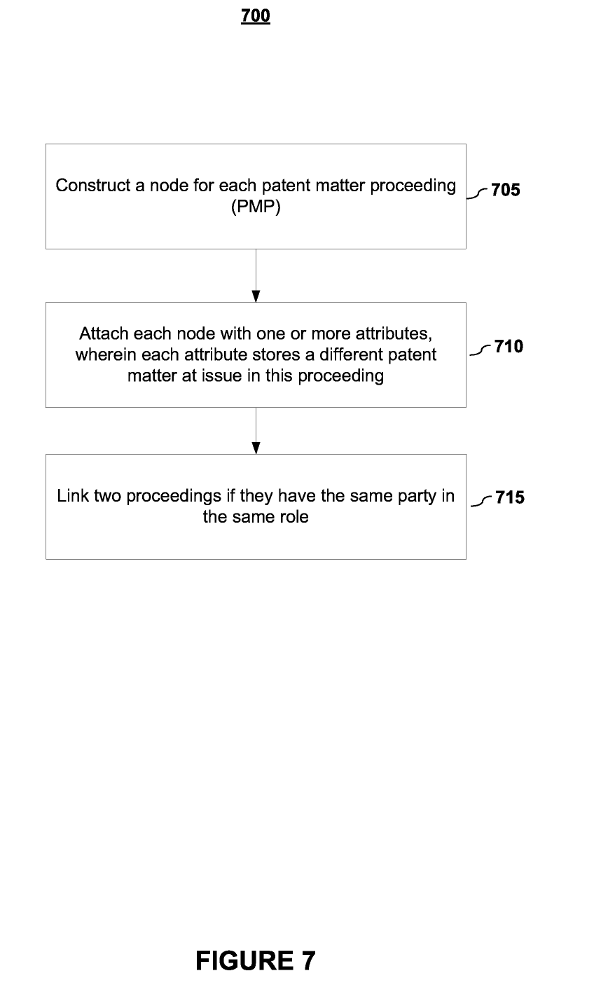

Returning to FIG. 2, in embodiments, the remaining step is to construct (240) a patent matter proceedings (PMP) graph using the patent matter proceedings with associated attributes. In embodiments, the graph may be constructed as described in FIG. 7.

FIG. 7 depicts a method for constructing a patent matter proceeding (PMP) graph according to embodiments of the present invention. First, one node is constructed (705) for each patent matter proceeding (e.g., litigations fetched from the district courts or ITC, reexaminations, protests, transactional matters, etc.). Each node is then attached or associated (710) with one or more attributes, wherein each attribute stores a different patent matter at issue in this proceeding. In embodiments, other attributes may be selected from the PMP's metadata (e.g., for a lawsuit: filing date, termination date (if applicable), district where filed, judge, parties involved (plaintiffs and defendants), judge, etc.). Lastly, in embodiments, a link is constructed (715) between two proceedings if they have the same party in the same role (e.g., Party X as defendant).

The embodiment depicted in FIG. 7 forms links based on shared parties, which represents one example of how links may be formed. It shall be noted that other types of nodes and other types of links are possible. For example, for a task that focuses on the behavior of law firms, links based on shared law firms could easily be generated using the same methodology.

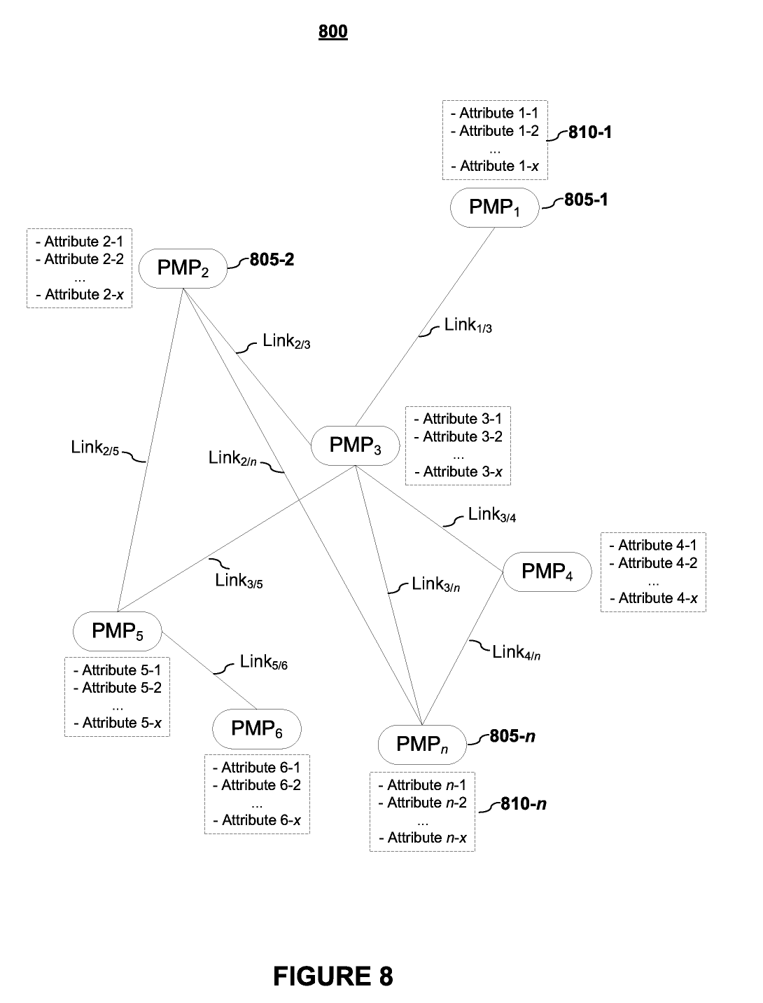

FIG. 8 depicts an example of a patent matter proceeding graph according to embodiments of the present invention. The graph shown in FIG. 8 represents n patent matters proceedings (PMP₁-PMPₙ). Each patent matter proceeding forms a node on the graph (e.g., 805-1 through 805-n). Associated with each node is a set of one or more attributes (e.g., 810-1 through 810-n). It shall be noted that, in embodiments, the number and types of attributes may not be the same for the nodes. Finally, as shown in FIG. 8, some of the nodes are connected via a link. In embodiments, the link may be a shared attributed between two of the nodes. Thus, for example, Link_{2/n} represents a shared attributed between an attributed associated with patent matter proceeding 2 (PMP₂) and an attributed associated with patent matter proceeding n (CPMPₙ). In embodiments, the shared attribute may be any of the associated attributes, such as common judge, same party, etc. It shall be noted that, in embodiments, nodes might possess no links, one link, or many links.

C. Similarity Models

1. Embodiments of Similarity Model Systems and Methods

Having extracted key information from various sources and having the ability to organize at least some of this extracted information into meaningful graphs, it shall be noted that application of those aspects of the present invention allow for development of techniques for measuring or gauging various factors among and between patent matters proceedings. For example, one application of the present invention comprises techniques to measure similarity between an input patent portfolio and other patent matters at issue in other proceedings.

Additionally, another aspect of the present invention is its ability to allow for the combining of different measures into a unified measure—that is, in embodiments, textual and non-textual information may be unified in gauging aspects of similarity in patent matters. Examples of measures presented below (for purposes of illustration and not limitation) address different aspects of similarity, such as textual similarity, similarity of proceedings, and similarity of industry (as may be defined implicitly by a set of companies).

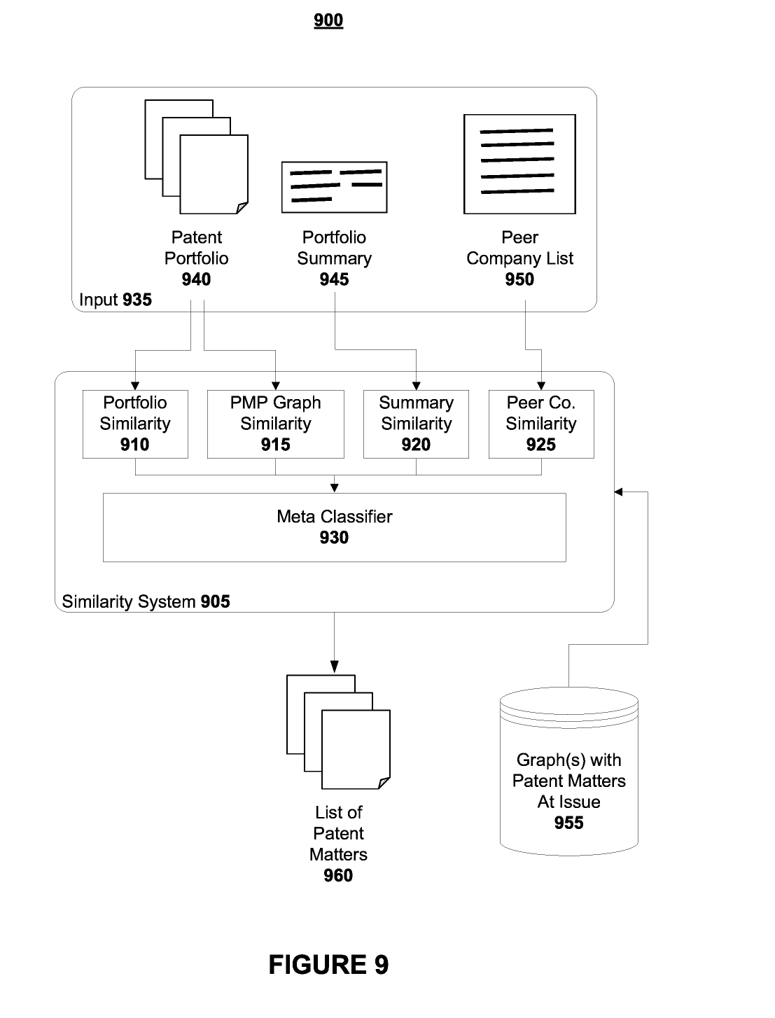

FIG. 9 depicts a system or architecture for generating patent similarity measures according to embodiments of the present invention. In embodiments, the system 900 comprises inputs 935, a similarity model 905, and, a list of patent matters 960 as output. Also depicted in FIG. 9 are one or more databases or data stores comprising the patent matters and associated graph(s) 955, which may be obtained as previously described.

In embodiments, the system 900 may be used to determine patent matter similarity. For example, system 900 may be used to find patent matters in proceedings that are similar to an input patent portfolio 940. Typically, this portfolio 940 will be instantiated with patent matters assigned to a company in a specific industry. The input portfolio 940 may contain any number of patents and/or patent applications, from one to several thousand. In embodiments, the input may also include a textual description 945 of the portfolio, a list of peer companies 950 (i.e., companies that participate in the industry of interest), or both. An example of a textual description of an input portfolio dealing with LCD television sets might be “liquid crystal display.” An example of a list of peer companies that operates in the industry of interest for that example portfolio (LCD television sets) may contain entities such as: Panasonic, Sony, LG, Samsung, etc.

In embodiments, one goal of the system is to find patent matters 960 that were previously at issue (e.g., previously a subject of a proceeding, such as a patent litigation or a licensing deal) and are most similar to the input portfolio 940. In embodiments, the output list 960 may be sorted in descending order of similarity, where the similarity measure is discussed in more detail below.

As noted above, oftentimes, prior attempts that relied solely on textual similarity were insufficient to identify related patent matters. For example, a patent that addresses a new glass cover and one for a new electronic chip might appear unrelated based on textual similarity alone. However, knowing that they were asserted in the same case against the same entity is strong indication that these patents are actually related because they apply on the same product (in this example, a smart phone). Thus, it is important that one measures not only textual similarity but also how patent matters interact in other situations. In embodiments, the similarity system 900 presented in FIG. 9 addresses these issues by combining up to four distinct similarity measures.

Portfolio Similarity.

In embodiments, the portfolio similarity component 910 measures the textual similarity between the input patent portfolio 940 and one or more patent matters. Any information retrieval (IR) algorithm may be used for this purpose, e.g., tf.idf (term frequency-inverse document frequency) similarity or latent semantic analysis. In embodiments, to align this task with the typical IR setup, one may consider the input portfolio as the input query and the set of patent matters as the document collection.

Patent Matter Proceeding (PMP) Graph Similarity.

The patent matter proceeding (PMP) graph similarity component 915 helps provide non-textual similarity. In embodiments, this module 915 defines the similarity between two patent matters based on how close they are in a PMP graph obtained using information from the graph database 955, wherein the closer the two matters are in a graph, the higher the similarity. In embodiments, the PMP graph contains as nodes patent matter proceedings. For example, “Visto Corporation v. Microsoft Corporation” is one such node. Another node might be an ex partes reexamination or an asset purchase agreement. In embodiments, an edge or link is created between two nodes if they share an attribute, such as the same party or the same party in the same role. For example, there is an edge between a node that represents “Visto Corporation v. Microsoft Corporation” and a node that represents “Sklar v. Microsoft Corporation” because the entity “Microsoft Corporation” appears as defendant in both cases. The distance between two patent matters is equal to the number of proceedings in the shortest path that connects the proceedings.

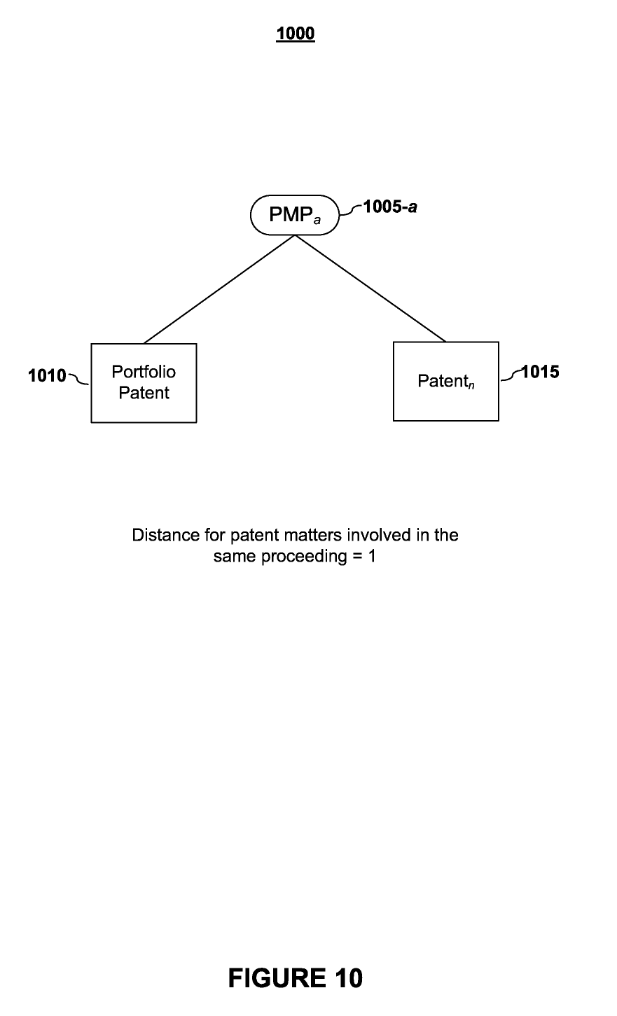

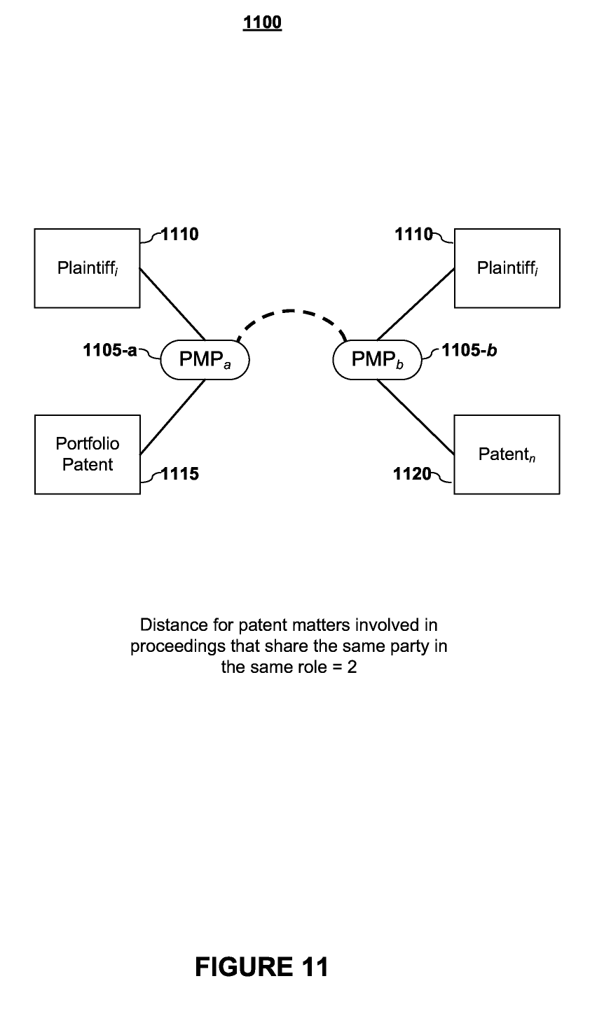

FIGS. 10 and 11 show two examples of measuring path distance according to embodiments of the present invention. FIG. 10 shows that the distance between two patents, a patent from the portfolio 1010 and another patent 1015 asserted in the same case PMPₐ 1005-a is 1. FIG. 11 shows that the distance between two patents at issue in two different proceedings, PMPₐ 1105-a and PMP_{b} 1105-b, initiated by the same plaintiff 1110 is 2.

In embodiments, the distance measure may be used as a basis for the similarity measure. For example, in embodiments, the PMP graph similarity measure may be defined as being inversely proportional with the distance measure. One skilled in the art shall recognize that other formula may be used. For example, a simplest formula may be similarity=1/distance, but other more complex formulas, such as ones that decrease the similarity value at a different linear rate or at a non-linear rate, may be used.

Summary Similarity.

In embodiments, the system 900 allows users to summarize their patent portfolio 940 with a short textual description 945 (e.g., “liquid crystal display” for a portfolio with inventions related to LCD screens). In embodiments in which this description 945 has been provided or generated, the textual similarity between this description 945 and patent matters may be used as a component in the similarity measure. Similarly to portfolio similarity 910 (described above), this textual similarity may be computed using any information retrieval (IR) measure.

Peer Company/Entity Similarity.

In embodiments, this module 925 allows similarity to be computed based on a set of peer companies/entities provided by the user. In embodiments in which such a list has been supplied or has been generated, the similarity of a patent matter with respect to this input may be computed as the maximum number of peer companies that participate in the same proceeding where the corresponding patent matter is at issue. The intuition is that the more peer companies' products are related to this patent matter, the more relevant this patent matter is likely to be. Note that, similarly to Patent Matter Proceeding (PMP) Graph Similarity, this information is independent of the textual content of the patent matter.

Meta Classifier.

It shall be noted that two or more of the above four similarity measures may be combined into a unique similarity score by the meta classifier 930 shown in FIG. 9. In embodiments, the meta classifier 930 linearly combines the similarity scores into a similarity value by assigning a weight to each similarity component. In embodiments, these weights may be the same or different, and these weights may be assigned or learned using a classifier and training data. In embodiments, the training process helps insure that these weights are assigned such that related patent matters (given in the training data) are ranked higher than other patent matters not related to the input portfolio. Training and using classifier models is well known to those of ordinary skill in the art; for example, any relevant machine learning (ML) algorithm (e.g., linear regression) may be used.

2. Example Use Case

An example use case is presented herein to demonstrate possession of the inventive aspects described in the current patent document. This use case is a specific example performed using specific embodiments and under specific conditions; accordingly, nothing in this use case section shall be used to limit the inventions of the present patent document. Rather, the inventions of the present patent document shall embrace all alternatives, modifications, applications and variations as may fall within the spirit and scope of the disclosure.

As a use case of this invention, consider the application that retrieves asserted patents similar to a given patent portfolio. Using this data, a customer can answer valuable questions, such as: “How often are patents similar to mine invalidated in litigation?” For example, such an input portfolio may include several tens of patents that focus on “flash memory” (i.e., the non-volatile computer storage chip used in solid-state disk drives (SSD)). Assume that this portfolio contains the patents listed in Table 1, among others. For simplicity, further assume that the customer did not provide a list of peer entities and did not provide a textual description of the input portfolio.

TABLE 1
Some patents in a “flash memory” portfolio

| Patent | |
|---|---|
| Number | Patent Title |
| 5,642,309 | Auto-program Circuit in a Nonvolatile Semiconductor |
| | Memory Device |
| 5,514,889 | Non-volatile Semiconductor Memory Device and Method |
| | for Manufacturing the Same |
| 5,473,563 | Nonvolatile Semiconductor Memory |
| 5,546,341 | Nonvolatile Semiconductor Memory |
| 6,728,798 | Synchronous Flash Memory with Status Burst Output |

In this configuration, an embodiment of the present invention starts by extracting the text of these patents and constructing a single, very large query using this entire text. This query is then used with an information retrieval (IR) system, such as Lucene (a free/open source information retrieval software library), to extract relevant patents. In the second step, the PMP/litigation graph is inspected and a score is assigned to each patent based on how close it is to patents in the input portfolio. In embodiments, a formula adds the value 1/distance for each portfolio patent seen within a distance of 3 nodes or less to the patent under consideration.

In embodiments, these two scores (textual similarity and PMP-graph similarity) are combined into a single value through linear interpolation:

OverallScore(candidate patent)=wₜₑₓₜxTextualSimilarity(candidate patent,portfolio)+w_{graph}×PMPGraphSimilarity(candidate patent,portfolio)

In embodiments, the weighting values wₜₑₓₜ=1.0 and w_{graph}=0.005 were used, but other weighting factor values may be used. As discussed above, these weights may be manually assigned, learned using a supervised ranking model such as linear regression, or a combination thereof.

Using this formula, the similarity system 905 retrieves and ranks patents. Table 2 lists the top three patents retrieved for the “flash memory” summarized in Table 1. The last column in Table 2 indicates whether human experts, upon review of the patents, considered the patents that were returned by the system to be relevant for the given portfolio.

TABLE 2
Top three patents retrieved for the domain “flash memory”
using both textual and PMP graph similarities

| | | Textual | PMP | Rele- |
|---|---|---|---|---|
| Patent | | Simi- | Graph | vant |
| Number | Patent Title | larity | Similarity | ? |
| 5,418,752 | Flash EEPROM System with | 0.0088 | 0.020 | Yes |
| | Erase Sector Reset | | | |
| 6,845,053 | Power Throughput Adjustment | 0.0017 | 0.025 | Yes |
| | in Flash Memory | | | |
| 6,654,847 | Top/Bottom Symmetrical | 0.0056 | 0.005 | No |
| | Protection Scheme for Plash | | | |

Table 2 indicates that the human experts marked the top two patents returned by the system as relevant. The ranks for both these patents were boosted based on the litigation/PMP-graph similarity measure. For example, the top patent (U.S. Pat. No. 5,418,752) was asserted jointly with the first four patents in Table 1 in the Samsung Electronics v. Sandisk Corporation (9:02-cv-00058-JH) matter. Thus, its litigation graph similarity has the value=0.005×(1/1+1/1+1/1+1/1)=0.020. This relatively high graph similarity score combined with the high textual similarity score (as produced by an IR engine) was sufficient to boost the rank of this patent to the top position.

To highlight the important results of the present invention, Table 3 (below) lists the top three patents found when the PMP graph similarity term is removed from the overall score. The table indicates that, in this case, several of the top patents are actually not relevant, even though they have a high textual similarity with the input portfolio. Furthermore, the top two patents in Table 2, which were marked as relevant, are now ranked much lower, at positions not in the top 20.

TABLE 3
Top three patents retrieved for the domain “flash
memory” using textual similarity alone

| | | Textual | PMP | Rele- |
|---|---|---|---|---|
| Patent | | Simi- | Graph | vant |
| Number | Patent Title | larity | Similarity | ? |
| 5,416,738 | Single Transistor EPROM Cell | 0.0214 | — | No |
| | and Method of Operation | | | |
| 6,034,897 | Space Management for | 0.0136 | — | Yes |
| | Managing High Capacity | | | |
| | Nonvolatile Memory | | | |
| 6,383,882 | Method for Fabricating MOS | 0.0114 | — | No |
| | Transistor Using Selective | | | |
| | Silicide Process | | | |

It shall be noted that this helps illustrate that textual similarity has limitations—namely, it only retrieve patent matters with a high textual overlap with the input portfolio. This limitation can be overcome by the approaches presented herein, which do not consider text only but also consider non-textual elements such as closeness on a PMP graph. In embodiments, a PMP-graph measure indicates how likely the patent matters are related. For example, in embodiments, PMP-graph measure indicates how likely it is that the same product (or related products) infringe on the patent to be ranked and patents in the portfolio. This measure has a strong indication that patent matters are related, even with minimal textual overlap.

D. Computing System Implementations

In embodiments, one or more computing system may be configured to perform one or more of the methods, functions, and/or operations presented herein. Systems that implement at least one or more of the methods, functions, and/or operations described herein may comprise an application or applications operating on at least one computing system. The computing system may comprise one or more computers and one or more databases. The computer system may be a single system, a distributed system, a cloud-based computer system, or a combination thereof.

It shall be noted that the present invention may be implemented in any instruction-execution/computing device or system capable of processing data, including, without limitation phones, laptop computers, desktop computers, and servers. The present invention may also be implemented into other computing devices and systems. Furthermore, aspects of the present invention may be implemented in a wide variety of ways including software (including firmware), hardware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

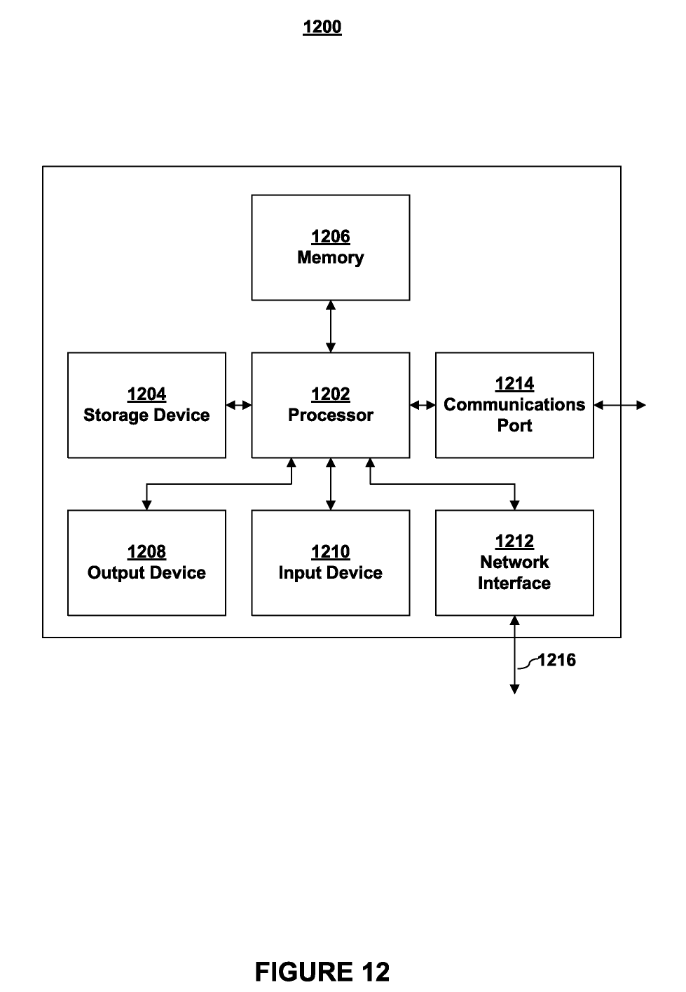

FIG. 12 depicts a functional block diagram of an embodiment of an instruction-execution/computing device 1200 that may implement or embody embodiments of the present invention, including without limitation a client and a server. As illustrated in FIG. 12, a processor 1202 executes software instructions and interacts with other system components. In an embodiment, processor 1202 may be a general purpose processor such as (by way of example and not limitation) an AMD processor, an INTEL processor, a SUN MICROSYSTEMS processor, or a POWERPC compatible-CPU, or the processor may be an application specific processor or processors. The processor or computing device may also include a graphics processor and/or a floating point coprocessor for mathematical computations. In embodiments, a storage device 1204, coupled to processor 1202, provides long-term storage of data and software programs. Storage device 1204 may be a hard disk drive and/or another device capable of storing data, such as a magnetic or optical media (e.g., diskettes, tapes, compact disk, DVD, and the like) drive or a solid-state memory device. Storage device 1204 may hold programs, instructions, and/or data for use with processor 1202. In an embodiment, programs or instructions stored on or loaded from storage device 1204 may be loaded into memory 1206 and executed by processor 1202. In an embodiment, storage device 1204 holds programs or instructions for implementing an operating system on processor 1202. In one embodiment, possible operating systems include, but are not limited to, UNIX, AIX, LINUX, Microsoft Windows, and the Apple MAC OS. In embodiments, the operating system executes on, and controls the operation of, the computing system 1200.

An addressable memory 1206, coupled to processor 1202, may be used to store data and software instructions to be executed by processor 1202. Memory 1206 may be, for example, firmware, read only memory (ROM), flash memory, non-volatile random access memory (NVRAM), random access memory (RAM), or any combination thereof. In one embodiment, memory 1206 stores a number of software objects, otherwise known as services, utilities, components, or modules. One skilled in the art will also recognize that storage 1204 and memory 1206 may be the same items and function in both capacities. In an embodiment, one or more of the methods, functions, or operations discussed herein may be implemented as modules stored in memory 1204, 1206 and executed by processor 1202.

In an embodiment, computing system 1200 provides the ability to communicate with other devices, other networks, or both. Computing system 1200 may include one or more network interfaces or adapters 1212, 1214 to communicatively couple computing system 1200 to other networks and devices. For example, computing system 1200 may include a network interface 1212, a communications port 1214, or both, each of which are communicatively coupled to processor 1202, and which may be used to couple computing system 1200 to other computer systems, networks, and devices.

In an embodiment, computing system 1200 may include one or more output devices 1208, coupled to processor 1202, to facilitate displaying graphics and text. Output devices 1208 may include, but are not limited to, a display, LCD screen, CRT monitor, printer, touch screen, or other device for displaying information. Computing system 1200 may also include a graphics adapter (not shown) to assist in displaying information or images on output device 1208.

One or more input devices 1210, coupled to processor 1202, may be used to facilitate user input. Input device 1210 may include, but are not limited to, a pointing device, such as a mouse, trackball, or touchpad, and may also include a keyboard or keypad to input data or instructions into computing system 1200.

In an embodiment, computing system 1200 may receive input, whether through communications port 1214, network interface 1212, stored data in memory 1204/1206, or through an input device 1210, from (by way of example and not limitation) a scanner, copier, facsimile machine, server, computer, mobile computing device (such as, by way of example and not limitation a phone or tablet), or other computing device.

In embodiments, computing system 1200 may include one or more databases, some of which may store data used and/or generated by programs or applications. In embodiments, one or more databases may be located on one or more storage devices 1204 resident within a computing system 1200. In alternate embodiments, one or more databases may be remote (i.e., not local to the computing system 1200) and share a network 1216 connection with the computing system 1200 via its network interface 1214. In various embodiments, a database may be a database that is adapted to store, update, and retrieve data in response to commands.

In embodiments, all major system components may connect to a bus, which may represent more than one physical bus. However, various system components may or may not be in physical proximity to one another or connected to the same bus. In addition, programs that implement various aspects of this invention may be accessed from a remote location over one or more networks or may be conveyed through any of a variety of machine-readable medium.

One skilled in the art will recognize no computing system or programming language is critical to the practice of the present invention. One skilled in the art will also recognize that a number of the elements described above may be physically and/or functionally separated into sub-modules or combined together.

It shall be noted that embodiments of the present invention may further relate to computer products with a tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A computer-implemented method for assessing similarity using non-textual information related to a patent matter proceeding or proceedings, the method comprising:
gathering data from one or more databases containing patent matter proceedings;
for each proceeding of at least some of the patent matter proceedings, extracting one or more patent matters at issue in the proceeding and one or more entities involved in the proceeding;
generating one or more nodes, each node representing a patent matter proceeding and having a set of associated attributes comprising the one or more patent matters at issue in the patent matter proceeding and the one or more entities involved in the patent matter proceeding;
constructing a graph by linking nodes based upon a shared attribute from the nodes' sets of associated attributes;
using the graph to calculate a distance measure between a patent matter at issue that is an associated attribute of a node in the graph and a patent matter from a patent portfolio comprising one or more patent matters that is also an associated attribute in a node in the graph; and
assigning a similarity score to the patent matter at issue using the distance measure.

2. The computer-implemented method of claim 1 wherein the one or more patent matters at issue in the proceeding are obtained by performing the steps comprising:
extracting a set of possible patent matters at issue in the proceeding; and
for each possible patent matter at issue from the set of possible patent matters at issue in the proceeding that appears in each of a set of word groupings with one or more keywords related to the proceeding, selecting the possible patent matters at issue as a patent matter at issue in the proceeding.

3. The computer-implemented method of claim 2 further comprising:
including at least one of the following scores when assigning the similarity score:
a portfolio similarity score that measures textual similarity between the patent portfolio and the patent matter at issue;
a summary similarity score that measures textual similarity between a summary of the patent portfolio and the patent matter at issue; and
a peer entities similarity score based upon a number of peer entities from a list of one or more entities that participate in a proceeding involving the patent matter at issue.

4. The computer-implemented method of claim 3 wherein the step of including at least one of the following scores when assigning the similarity score comprises:
assigns the similarity score to the patent matter at issue by linearly combining a first weight multiplied by an inverse of the distance measure, a second weight multiplied by the textual similarity score between the patent portfolio and the patent matter at issue, a third weight multiplied by the textual similarity score between the summary of the patent portfolio and the patent matter at issue, and a fourth weight multiplied by the peer similarity score.

5. The computer-implemented method of claim 1 wherein the step of gathering data from one or more databases containing patent matter proceedings further comprises:
responsive to a database having a limitation regarding accessing data:
examining text to detect important events of a proceeding; and
downloading documents associated with the detected important events of the proceeding;
and
responsive to a database having no limitation:
downloading all documents related to a proceeding.

6. A non-transitory computer-readable medium or media comprising one or more sequences of instructions which, when executed by one or more processors, causes steps to perform the method of claim 1.

7. A computer-implemented similarity system that assessing similarity between patent matters, the system comprising:
a patent-matter-proceeding-graph similarity module that:
receives as an input a patent portfolio comprising one or more patent matters;
is communicatively coupled to a data store comprising one or more patent-matter-proceeding graphs, a patent-matter-proceeding graph comprising:
one or more nodes, each node representing a proceeding and having one or more associated attributes wherein at least one of the associated attributes is a patent matter at issue for the proceeding, and
links joining two nodes that share an associated attribute; and
outputs a distance measure between a patent matter at issue that is an associated attribute of a node in a patent-matter-proceeding graph and a patent matter in the patent portfolio that is also an associated attribute in a node in the patent-matter-proceeding graph; and
a meta classifier that receives the distance measure and assigns a similarity score to the patent matter at issue using the distance measure.

8. The computer-implemented similarity system of claim 7 wherein the similarity score comprises a factor that is inversely proportional to the distance measure.

9. The computer-implemented similarity system of claim 8 further comprising:
a portfolio similarity module that:
receives as an input the patent portfolio comprising one or more patent matters;
measures textual similarity between the patent portfolio and the patent matter at issue; and
outputs to the meta classifier a textual similarity score between the patent portfolio and the patent matter at issue; and
the meta classifier further configured to receives the textual similarity score and assigns the similarity score to the patent matter at issue using the distance measure associated with that patent matter at issue and the textual similarity score between the patent portfolio and the patent matter at issue.

10. The computer-implemented similarity system of claim 9 comprising:
a summary similarity module:
that receives as an input a summary of the patent portfolio;
measures textual similarity between the summary of the patent portfolio and the patent matter at issue; and
outputs to the meta classifier a textual similarity score between the summary of the patent portfolio and the patent matter at issue; and
the meta classifier further configured to receives the textual similarity score and assigns the similarity score to the patent matter at issue using the distance measure associated with that patent matter at issue, the textual similarity score between the patent portfolio and the patent matter at issue, and the textual similarity score between the summary of the patent portfolio and the patent matter at issue.

11. The computer-implemented similarity system of claim 9 comprising:
a peer entities similarity module that:
receives as an input a listing of one or more entities related to the patent portfolio;
measures a peer similarity score based upon a number of peer entities from the list of one or more entities that participate in a proceeding involving the patent matter at issue; and
outputs to the meta classifier the peer similarity score; and
the meta classifier further configured to receives the peer similarity score and assigns the similarity score to the patent matter at issue using the distance measure associated with that patent matter at issue, the textual similarity score between the patent portfolio and the patent matter at issue, and the peer similarity score.

12. The computer-implemented similarity system of claim 10 comprising:
a peer entities similarity module that:
receives as an input a listing of one or more entities related to the patent portfolio;
measures a peer similarity score based upon a number of peer entities from the list of one or more entities that participate in a proceeding involving the patent matter at issue; and
outputs to the meta classifier the peer similarity score; and
the meta classifier further configured to receives the peer similarity score and assigns the similarity score to the patent matter at issue using the distance measure associated with that patent matter at issue, the textual similarity score between the patent portfolio and the patent matter at issue, the textual similarity score between the summary of the patent portfolio and the patent matter at issue, and the peer similarity score.

13. The computer-implemented similarity system of claim 12 wherein:
the meta classifier assigns the similarity score to the patent matter at issue by linearly combining a first weight multiplied by an inverse of the distance measure, a second weight multiplied by the textual similarity score between the patent portfolio and the patent matter at issue, a third weight multiplied by the textual similarity score between the summary of the patent portfolio and the patent matter at issue, and a fourth weight multiplied by the peer similarity score.

14. The computer-implemented similarity system of claim 13 wherein:
at least two of the first weight, second weight, third weight, and fourth weight are the same value.

15. A computer-implemented method for creating non-textual representation related to patent matter proceeding or proceedings, the method comprising:
gathering data from one or more databases containing patent matter proceedings;
for each proceeding of at least some of the patent matter proceedings, extracting a set of patent-matter-proceeding information, the set of patent-matter-proceeding information comprising one or more patent matters at issue in the proceeding and one or more entities involved in the proceeding;
generating one or more nodes using at least some of the patent-matter-proceeding information, each node comprising a set of associated attributes; and
constructing a graph by linking nodes based upon a shared attribute from the nodes' sets of associated attributes.

16. The computer-implemented method of claim 15 wherein the step of extracting one or more patent matters at issue in the proceeding comprises:
extracting a set of possible patent matters at issue in the proceeding; and
for each possible patent matter at issue from the set of possible patent matters at issue in the proceeding that appears in each of a set of word groupings with one or more keywords related to the proceeding, selecting the possible patent matters at issue as a patent matter at issue in the proceeding.

17. The computer-implemented method of claim 16 further comprising:
removing from the set of possible patent matters at issue any patent matter that is an outlier or that differs slightly from another possible patent matters at issue in that set of possible patent matters at issue that occurs more frequently in the gathered data for the proceeding; and
wherein the set of work groupings comprises two or more word groupings.

18. The computer-implemented method of claim 15 wherein the step of extracting one or more entities involved in the proceeding comprises:
extracting a set of entity names in the proceeding;
for each entity name in the set of entity names having a common prefix or suffix, removing the common prefix or suffix;
for each entity name in the set of entity names having a common term from a set of common terms, converting the common term to a normalized form; and
responsive to an entity name being the same as another entity in the set of entity names, mapping the entity names to a single unique name.

19. The computer-implemented method of claim 15 wherein:
a node represents a patent matter proceeding and the set of associated attributes comprises the one or more patent matters at issue in the patent matter proceeding and the one or more entities involved in the patent matter proceeding; and
the shared attribute is one or more entities in a same role.

20. A non-transitory computer-readable medium or media comprising one or more sequences of instructions which, when executed by one or more processors, causes steps to perform the method of claim 15.
